(19) United States
(12) Patent Application Publication
(10) Pub. No.: US 2026/0007128 A1
(43) Pub. Date: Jan. 8, 2026

(54) AI-Enhanced Animal Deterrent and Safety System Featuring Modular Deployment, Context-Aware Vision, and Multimodal Directional Output

(71) Applicant: Anthony Radford, Fayetteville, GA (US)

(72) Inventor: Anthony Radford, Fayetteville, GA (US)

(21) Appl. No.: 18/831,765

(22) Filed: Aug. 15, 2025

Related U.S. Application Data
(63) Continuation-in-part of application No. 18/142,081, filed on May 2, 2023, now Pat. No. 12,465,043.

(51) Int. Cl. A01M 29/10; A01K 29/00

(52) U.S. Cl. CPC A01M 29/10; A01K 29/00

(57) ABSTRACT

An intelligent, humane animal deterrent system utilizing AI and multivision sensor fusion for real-time species recognition and behavioral threat assessment. The system integrates thermal and RGB cameras, motion and acoustic sensors, RFID scanning, and secure voice command. Non-lethal directional deterrents—ultrasonic sound, LED arrays, and vibration—are mounted on precision swivel-tilt mechanisms for dynamic targeting. Modular deployment supports handheld, wearable, fixed, and drone-mounted configurations via universal, tool-free attachments. AI processing is hybrid, combining edge computing and cloud-based neural networks. A hybrid communication module enables mesh networking, satellite links, and emergency beacons with automatic fallback. Power is managed by dual batteries and optional solar charging. Smart displays and AR eyewear offer real-time ID and safety guidance. Voice commands support hands-free, multi-language use. The system improves personal safety, protects property, and promotes humane wildlife interaction and conservation.

### CROSS-REFERENCE TO RELATED APPLICATIONS

This application is a Continuation-in-Part of U.S. patent application Ser. No. 18/142,081, filed on May 2, 2023, entitled “A Portable Hand-Held Device Utilized to Deter a Canine Attack,” which is hereby incorporated by reference in its entirety.

### DOCUMENT STRUCTURE NOTE

Figure and claim numbering continues sequentially from the original patent (FIG. 1-7, claims 1-20) to the new CIP content (FIG. 8-22, claims 21-55) to maintain numerical continuity and avoid confusion.

### FIELD OF THE INVENTION

This invention relates generally to intelligent humane animal deterrent systems, and more specifically to AI-enhanced hybrid systems with modular deployment capabilities for non-lethal wildlife management, agricultural protection, personal safety, and emergency response applications. The invention encompasses advanced sensor fusion technologies, artificial intelligence processing, voice command integration, universal attachment mechanisms, and hybrid communication systems designed to provide comprehensive animal deterrent solutions across diverse deployment scenarios including handheld, wearable, fixed-mounted, and drone-mounted configurations.

### BACKGROUND OF THE INVENTION

Animal intrusions into human environments—including residential areas, agricultural zones, recreational spaces, and urban settings—present significant and escalating risks to public safety, personal property, and domesticated animals. Current deterrent technologies rely predominantly on static alarm systems, physical barriers, or manually activated devices that lack the intelligence and adaptability necessary to differentiate between harmless and threatening animal behaviors or to respond appropriately to diverse species and environmental contexts.

Existing solutions suffer from critical limitations including: (1) inability to distinguish between species or assess behavioral intent, leading to inappropriate responses and unnecessary environmental disruption; (2) lack of real-time adaptability to changing conditions or animal behavior patterns; (3) limited deployment flexibility restricting effectiveness across diverse environments and use cases; (4) absence of intelligent targeting capabilities resulting in inefficient deterrent application; (5) inadequate integration with modern communication and emergency response systems; and (6) limited data collection and learning capabilities preventing system optimization over time.

Furthermore, contemporary applications increasingly demand advanced capabilities including: autonomous operation for extended monitoring periods; modular deployment across handheld, wearable, fixed, and aerial platforms; integration with smart devices and augmented reality systems; emergency communication capabilities in remote locations; pet identification and recovery functions; and comprehensive data logging for behavioral analysis and system improvement.

The proliferation of outdoor recreational activities, agricultural expansion into wildlife habitats, and increasing human-wildlife interface conflicts have intensified the need for intelligent, adaptive deterrent systems capable of operating effectively across diverse environmental conditions while minimizing ecological impact. Additionally, the growing emphasis on personal safety in outdoor environments, particularly for vulnerable populations including children and elderly individuals, necessitates advanced warning and protection systems that can operate autonomously while providing real-time situational awareness.

Existing technologies fail to address the complex requirements of modern animal deterrent applications, including the need for: species-specific response protocols based on behavioral assessment; multi-modal deterrent capabilities adaptable to different animal types and environmental conditions; seamless integration with emergency response and communication systems; comprehensive data collection for pattern analysis and system optimization; and modular deployment flexibility enabling effective operation across diverse use cases and environments.

The present invention addresses these critical shortcomings through an AI-enhanced hybrid animal deterrent and safety system that combines advanced sensor fusion, intelligent processing, modular deployment capabilities, and comprehensive communication integration to provide effective, adaptive, and environmentally responsible animal deterrent and safety solutions across a wide range of applications and environmental conditions.

### SUMMARY OF THE INVENTION

The present invention provides an advanced AI-enhanced hybrid humane animal deterrent and safety system that addresses the limitations of existing technologies through intelligent sensor fusion, modular deployment capabilities, and non-lethal adaptive response mechanisms.

The system integrates multiple advanced technologies including thermal imaging cameras, RGB cameras, motion detection sensors, acoustic detectors, RFID scanning capabilities, and voice command modules to create a comprehensive environmental monitoring and threat assessment platform. The multivision sensor fusion system processes data through hybrid artificial intelligence combining local edge computing and cloud-based neural networks for accurate species identification and behavioral analysis.

The modular design enables deployment across multiple configurations including handheld operation with detachable handles, wearable integration into safety vest systems, fixed-mounted installations for perimeter defense, and drone-mounted configurations for autonomous aerial patrol. Universal attachment mechanisms provide tool-free reconfiguration between deployment modes while maintaining secure, weatherproof connections.

The humane deterrent system employs directional emitters including ultrasonic speakers, high-intensity LED arrays, and vibration actuators mounted on precision swivel and tilt mechanisms for dynamic targeting. The system provides targeted non-lethal deterrence with minimal environmental disruption through AI-controlled output selection based on species identification and behavioral assessment.

Voice command integration enables hands-free operation with multi-language support, user voice pattern recognition for enhanced security, and emergency activation capabilities. The system processes voice commands for system control, deterrent activation, mode selection, and emergency response coordination.

Communication capabilities include hybrid networking supporting mesh connectivity, satellite links, and mobile network interfaces with automatic fallback logic ensuring reliable operation in remote environments. Emergency beacon functionality provides distress signal transmission and automatic location broadcasting through multiple communication pathways.

Power management features dual-battery configuration with intelligent charging management, solar supplementation, weatherproof housing, and thermal safety mechanisms for extended operation across diverse environmental conditions. The system includes comprehensive data logging and adaptive learning algorithms for continuous improvement and optimization.

Integration with smart displays and augmented reality eyewear provides real-time specie identification overlays, behavioral threat indicators, safety recommendations, and voice-guided instructions for enhanced user situational awareness and safety response capabilities.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 8—Perspective view of the AI-enhanced humane animal deterrent system (336) in handheld configuration, showing the enhanced head portion (338), detachable handle (340), directional emitters (358), control interface (344), voice command module (412), universal attachment mechanisms (414), weatherproof sealed battery compartments (342), LED indicators (346), USB charging ports (348), status indicators (354), user control buttons (360), and ergonomic grip contours (352).

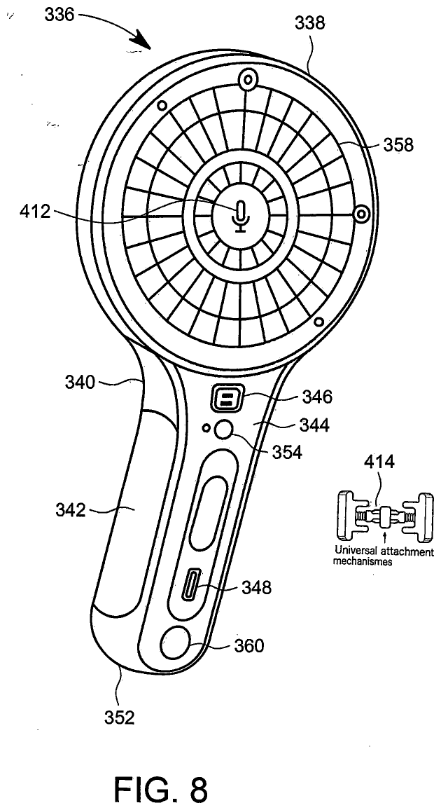

FIG. 9—Exploded view of the handheld system illustrating internal components: enhanced head portion (338), dual RGB cameras (402), thermal imaging cameras (404), RFID scanner (410), voice command module (412), microprocessor (422), AI module (420), directional emitters (358), multisession sensor fusion system (400), universal attachment mechanisms (414), detachable handle (340), control interface (344), LED indicators (346), status indicators (354), user control buttons (360), and weatherproof battery compartments (342).

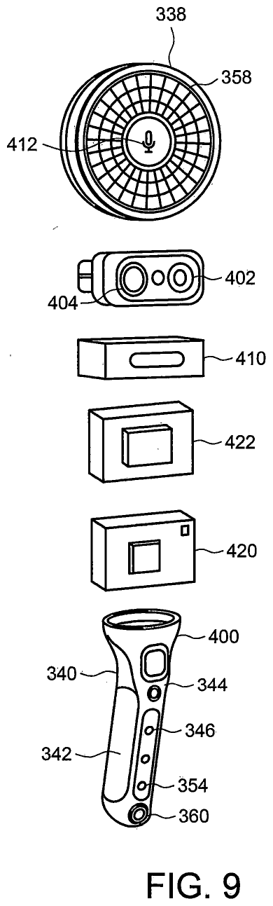

FIG. 10—Schematic of the multivision sensor fusion system (400), combining inputs from thermal imaging cameras (404), RGB cameras (402), motion detection sensors (406), acoustic detectors (408), and voice command module (412) into a unified analysis stream processed by the hybrid onboard AI engine (432) for species recognition (426) and behavioral threat assessment (428).

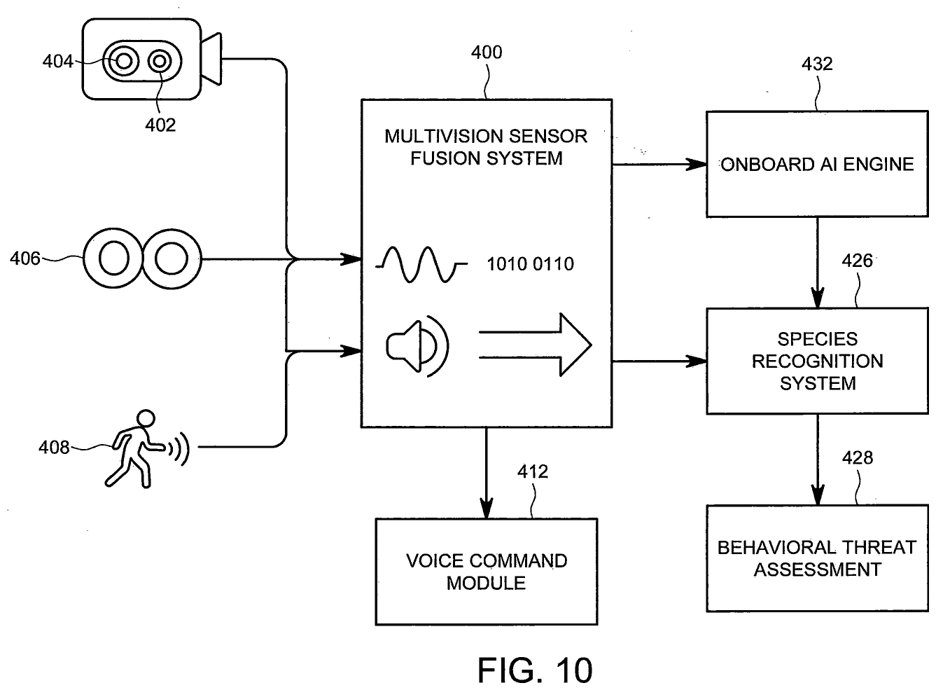

FIG. 11—Swivel and tilt actuator mechanism comprising swivel mechanism (502) and tilt adjustment (504) supporting the directional output module (358), enabling real-time targeting of detected animal threats via dynamic targeting system (510) with mounting platform (512) and voice command control integration.

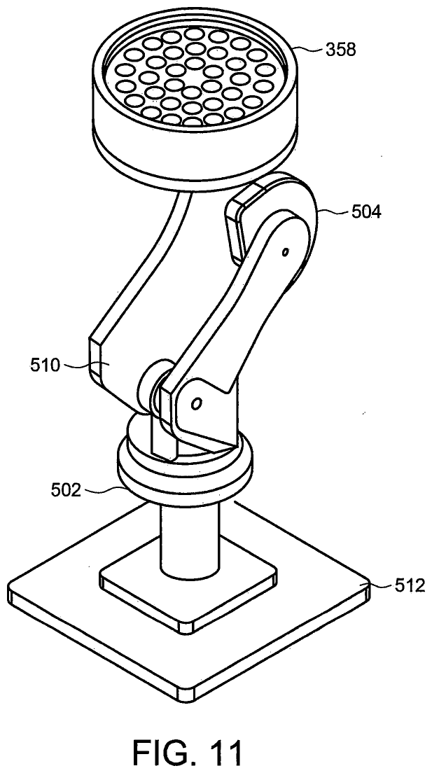

FIG. 12—The detachable handle portion (340), shown separately, with integrated solar charging capability (350), user control buttons (360), weatherproof battery compartment (342), status indicators (354), LED indicators (346), USB charging ports (348), ergonomic grip contours (352), and voice command interface connectivity.

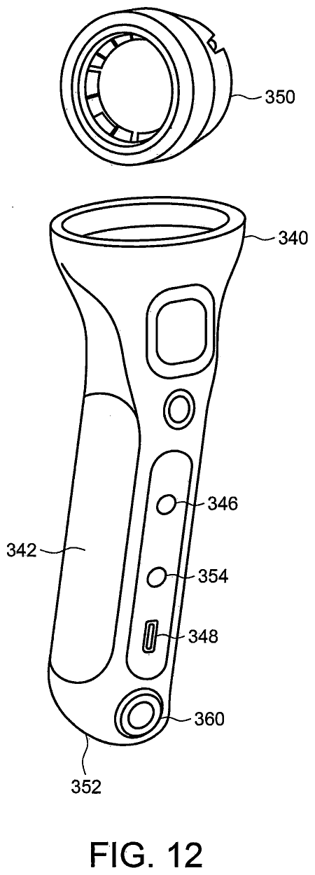

FIG. 13—Wearable configuration integrated into a safety vest integration system (522), with the enhanced head portion (338) mounted to the chest area via chest mounting (524) and universal attachment mechanisms (414), connected via harness attachment points (528), and voice command module (412) for hands-free operation.

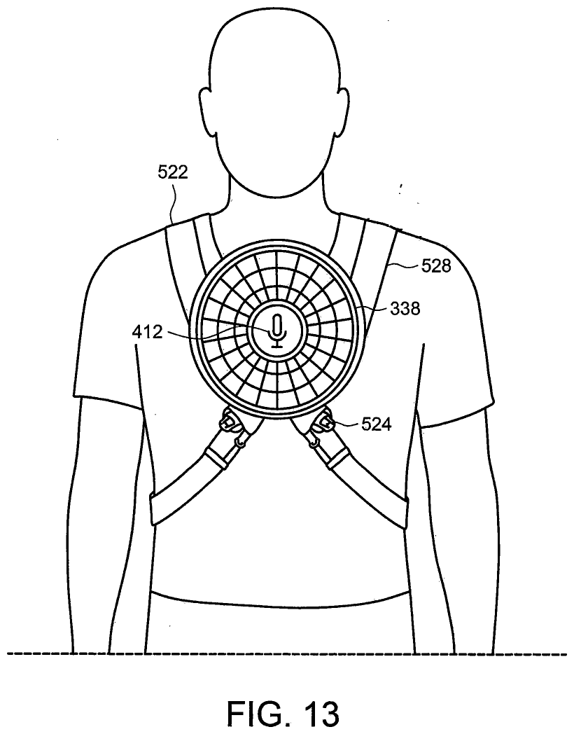

FIG. 14—Fixed-mounted configuration for stationary perimeter defense, showing the enhanced head portion (338) attached to a fencepost (534) via universal attachment mechanisms (414) and mounting platform (510), with power cable routing (536), emitter orientation controls (538), and base platform (512) for stable installation.

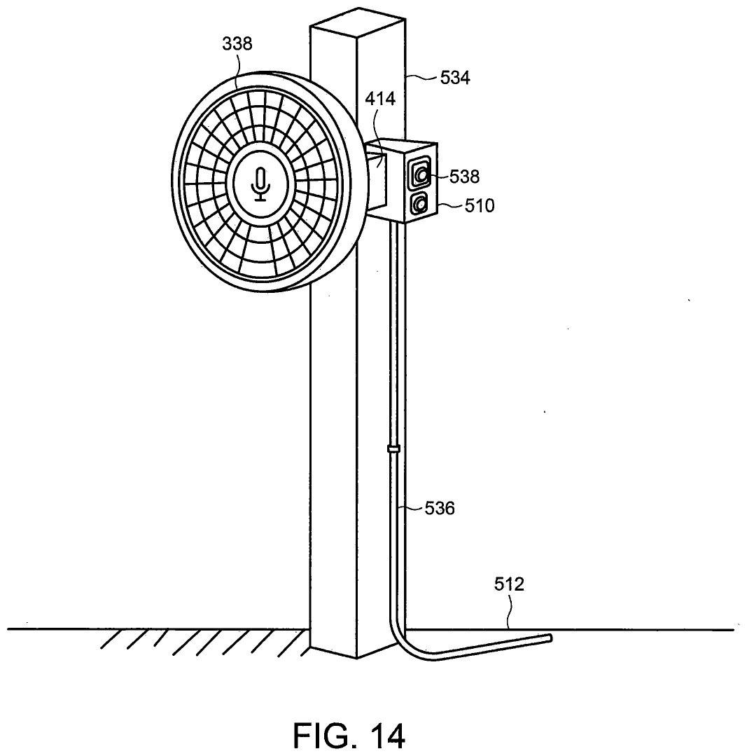

FIG. 15—Drone-mounted configuration, including the AI-enhanced humane animal deterrent system (336) with enhanced head portion (338) mounted via gimbal-mounted head unit (516), universal attachment mechanisms (414), wireless sync interface (518), voice command module (412), and flight navigation overlays (520) used for autonomous aerial patrol.

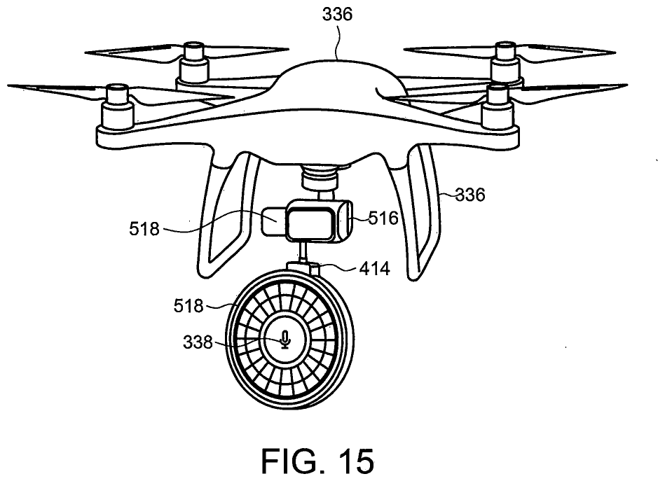

FIG. 16—Independent aerial deterrent head operating wirelessly from the drone platform, showing stabilized housing (516), enhanced head portion (338), directional emitters (358), voice command module (412), universal attachment mechanisms (414), onboard battery module (342), and wireless communication (608) for coordinated operation.

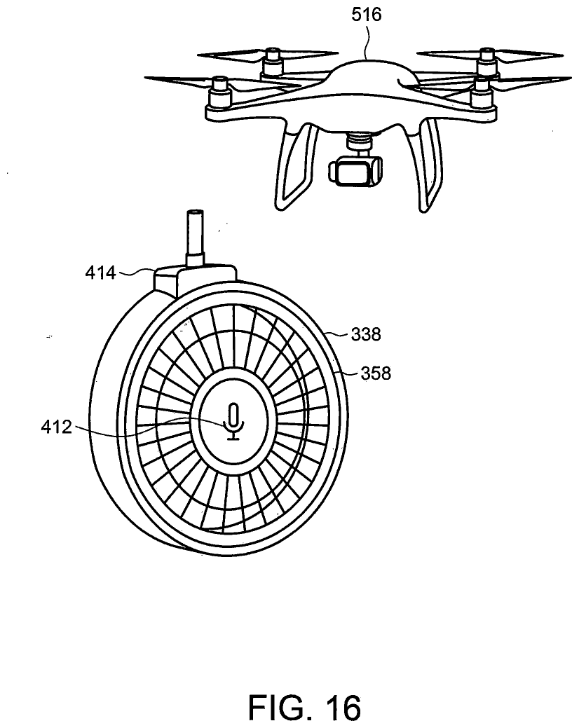

FIG. 17—Smart display or AR eyewear interface (614) showing real-time overlays (616) of detected species identification (618), behavior type indicators (620), suggested deterrent actions (622), and voice-guided graphical guidance (626) via avatars and icons for enhanced user interaction.

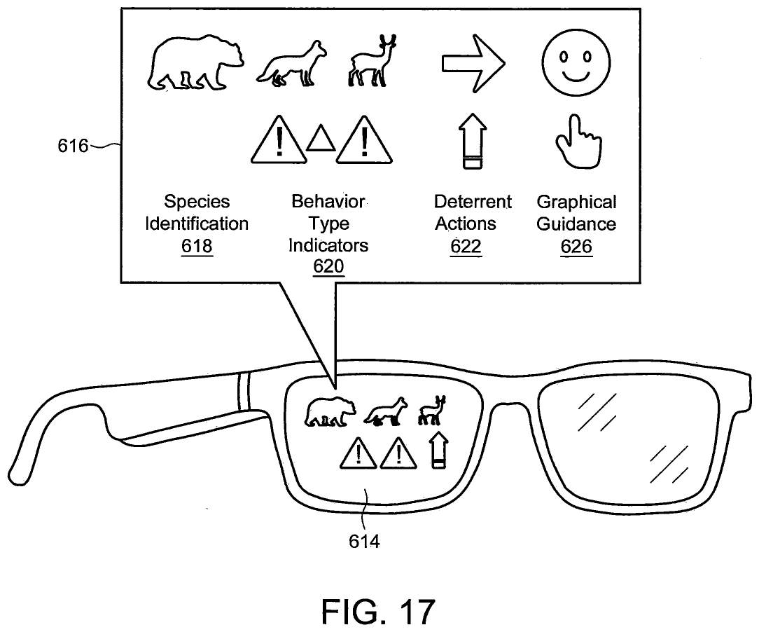

FIG. 18—Mobile application UI interface (628) showing status indicators (354), real-time alerts (632), manual deterrent control options (634), emergency beacon activation (610), voice command configuration settings, RFID scan data display (410), and species detection records (818) for comprehensive system monitoring.

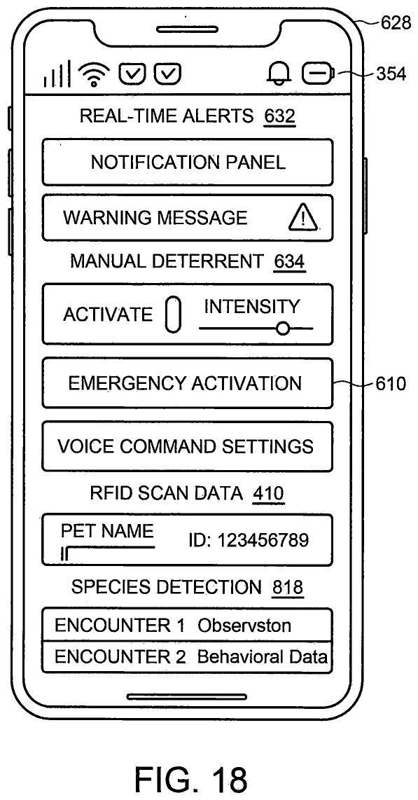

FIG. 19—Communication module schematic showing the hybrid communication module (600) with mesh network interface (602), satellite connectivity (604), mobile network interface (606), wireless communication (608), voice command integration (412), including fallback logic and data flow paths between cloud-based AI processing (434) and local edge processor (422).

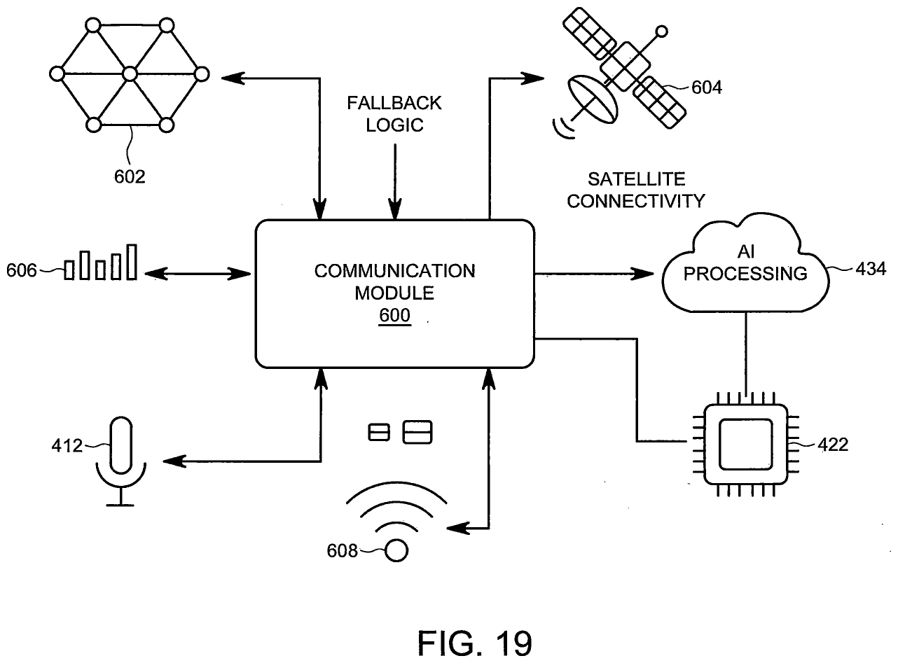

FIG. 20—Battery and power management schematic showing hybrid dual-battery configuration (700) with primary battery pack (702), secondary battery (704), weatherproof battery housing (708), thermal safety mechanisms (718), solar charging pathway (712), USB-C charging ports (714), runtime diagnostics (716), and battery management system (710).

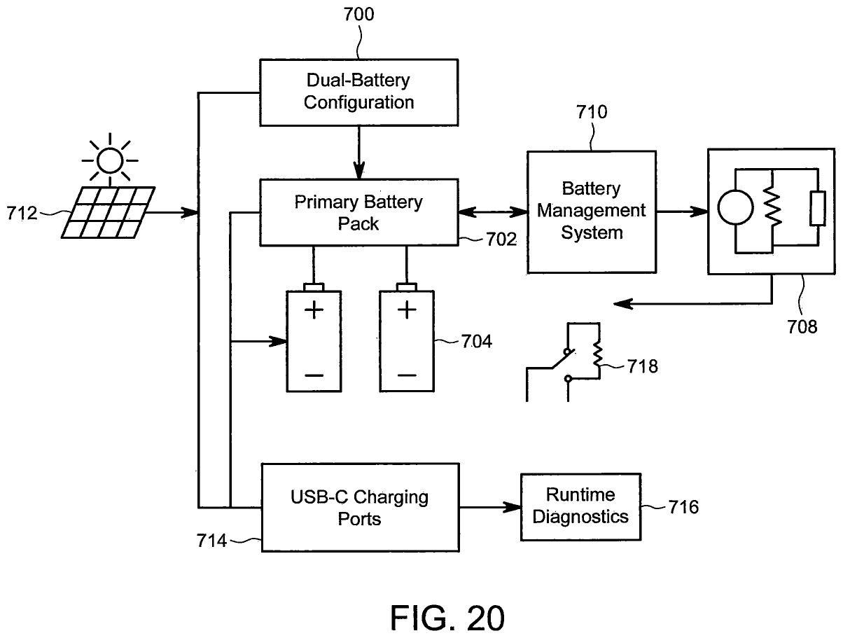

FIG. 21—Logic flow diagram for autonomous operation logic (800), showing state transitions (802) between passive monitoring mode (804), active deterrence mode (806), and emergency beacon mode (808) based on contextual sensor input (810), environmental conditions (830), and voice command inputs from voice command module (412).

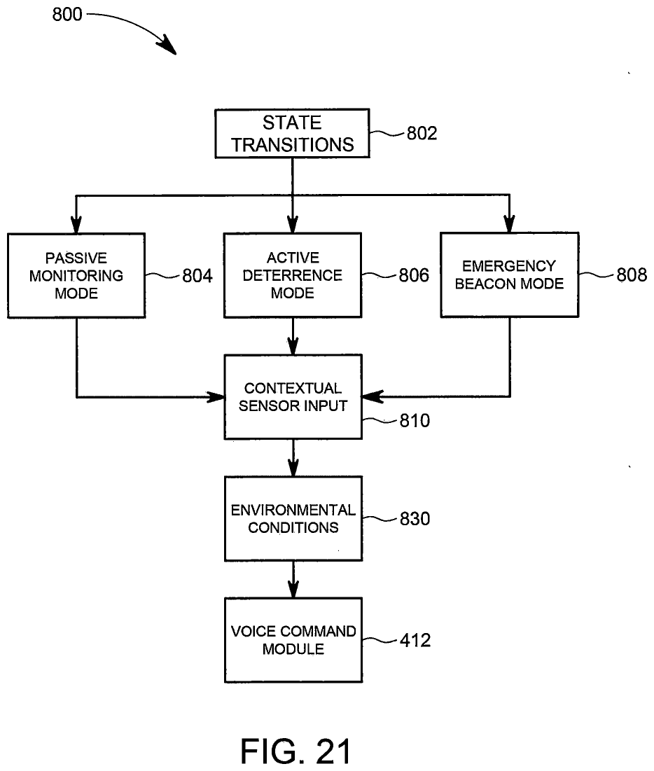

FIG. 22—Memory and logging module architecture (812) storing sensor events storage (816), species detection records (818), deterrent response patterns (820), user overrides (822), voice command logs (824), and adaptive algorithms (826) for continuous system learning and optimization.

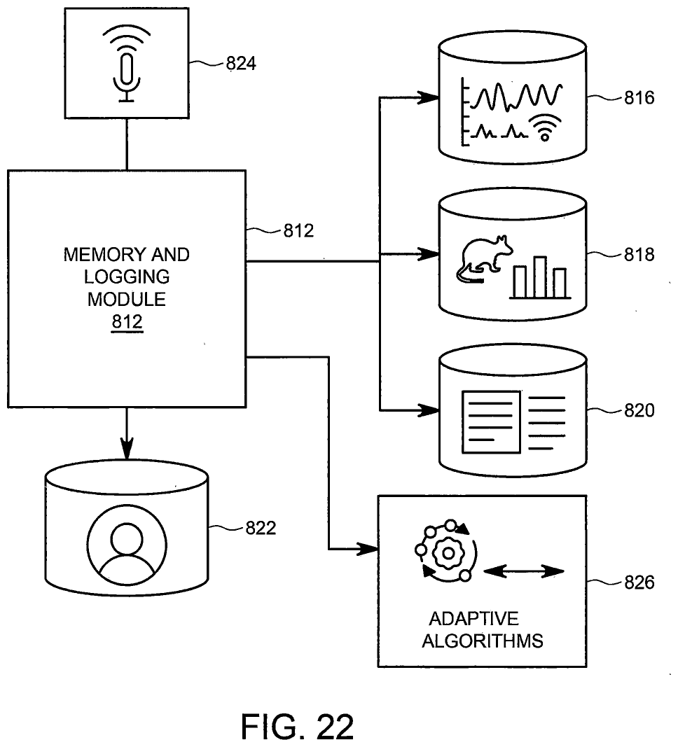

### DETAILED DESCRIPTION OF THE INVENTION

The present invention relates to an advanced, AI-powered hybrid humane animal deterrent and safety system (336) employing context-aware computer vision with multivision sensor fusion (400) to monitor, assess, and humanely deter potentially hazardous animals through non-lethal methods. This sophisticated hybrid system integrates thermal imaging cameras (404), RGB video cameras (402), motion detection sensors (406), acoustic sensors (408), RFID scanning capabilities (410), and a voice command module (412) for comprehensive environmental analysis and real-time behavior assessment capabilities.

The core component is the enhanced head portion (338), which houses dual high-resolution RGB cameras (402), acoustic sensors (408), RFID scanners (410), thermal imaging detectors (404), and a voice command module (412) for precise animal identification, behavioral analysis, and hands-free user interaction. The voice command module (412) integrates seamlessly with the existing hybrid communication module (600) to provide multi-language support, emergency voice activation capabilities, and user voice pattern recognition for enhanced security. Data from these sensors feeds into an onboard AI module (420) leveraging hybrid local edge processing (422) and cloud-based neural networks (434) to deliver species recognition (426), behavioral threat assessment (428), and context-aware operational responses.

The enhanced head portion (338) features universal attachment mechanisms (414) enabling secure mounting to vest harnesses, post installations, drone platforms, and various deployment configurations. The attachment mechanisms (414) include quick-release connectors, threaded mounting interfaces, adjustable clamp systems, and weatherproof sealing for versatile deployment across multiple configurations with tool-free operation and vibration-resistant connections.

The humane deterrent outputs comprise directional emitters (358) including ultrasonic speakers, high-intensity LED arrays, and vibration actuators, mounted on adaptive swivel and tilt mechanisms (502, 504) for dynamic tracking of animal movement, ensuring targeted non-lethal deterrence with minimal environmental disruption. The dynamic targeting system (510) provides precision positioning control through the mounting platform (512) and base platform (512) for stable operation.

Autonomous or manual operation is provided via a mobile application interface (628) and the integrated voice command module (412), enabling customizable responses through manual deterrent control options (634), voice-activated commands, real-time alerts (632), and comprehensive system monitoring via status indicators (354). The voice command module (412) supports multiple languages and can process commands including system activation, deterrent mode selection, emergency beacon activation, and status inquiries.

Deployment versatility supports handheld, wearable, fixed-mounted, and drone-mounted configurations through the universal attachment mechanisms (414). The handheld version features a detachable handle (340) with integrated user control buttons (360), LED indicators (346), USB charging ports (348), and solar energy supplementation (350). The weatherproof battery compartments (342) are strategically located within both the enhanced head portion (338) and detachable handle (340) for balanced weight distribution, protection from environmental elements, and efficient energy management through the hybrid battery management system (710).

The wearable format integrates seamlessly into a vest integration system (522) with chest mounting (524) for the enhanced head portion (338) utilizing the universal attachment mechanisms (414) for secure harness connection via harness attachment points (528), delivering mobile deterrence and real-time user alerts while maintaining hands-free operation through the voice command module (412) for optimal user mobility and safety.

The drone-mounted configuration enables semi-autonomous aerial patrols of agricultural fields, campsites, recreational areas, or protected natural environments. The enhanced head portion (338) operates independently through a gimbal-mounted head unit (516), wirelessly interfacing with the drone platform via wireless sync interface (518) and flight navigation overlays (520) to perform precise monitoring, species tracking, and proactive deterrence with voice command control capabilities.

Integration with smart displays or AR eyewear (614) delivers augmented reality overlays (616) identifying animal species through species identification (618), behavior type indicators (620), and recommended safety actions (622) through intuitive graphical guidance (626). The voice command module (412) provides audio feedback and voice-guided instructions through the AR interface, enhancing user situational awareness and safety response capabilities.

Communication capabilities include a comprehensive hybrid communication module (600) supporting mesh network interface (602), satellite connectivity (604), mobile network interface (606), and wireless communication (608) for emergency beacon functions (610), environmental navigation, and remote monitoring. The voice command module (412) integrates with all communication pathways, ensuring reliable operation in remote or challenging environments through intelligent fallback logic between cloud-based AI processing (434) and local edge processor (422).

The power management system features a hybrid dual-battery configuration (700) with primary battery pack (702), secondary battery (704), and weatherproof battery housing (708). Solar charging pathway (712), USB-C charging ports (714), runtime diagnostics (716), thermal safety mechanisms (718), and the hybrid battery management system (710) ensure reliable operation across diverse environmental conditions with intelligent energy optimization and extended operational duration.

The autonomous operation logic (800) manages intelligent state transitions (802) between passive monitoring mode (804), active deterrence mode (806), and emergency beacon mode (808) based on contextual sensor input (810), environmental conditions (830), and voice command inputs from the voice command module (412). This adaptive system ensures appropriate responses while conserving power and minimizing environmental disruption.

The memory and logging module (812) provides comprehensive data management including sensor events storage (816), species detection records (818), deterrent response patterns (820), user overrides (822), voice command logs (824), and adaptive algorithms (826) for continuous improvement and optimization. This data enables system learning and enhanced performance over time through pattern recognition and response effectiveness analysis.

The multivision sensor fusion system (400) combines inputs from thermal imaging cameras (404), RGB cameras (402), motion detection sensors (406), acoustic detectors (408), and voice command module (412) into a unified analysis stream processed by the hybrid onboard AI engine (432) for accurate species recognition and comprehensive behavioral analysis with real-time threat assessment capabilities.

Fixed-mounted configurations utilize the universal attachment mechanisms (414) with mounting platforms (510) and base platforms (512) for stationary deployment applications, featuring power cable routing (536) and emitter orientation controls (538) for perimeter defense installations including secure attachment to fenceposts (534) or other mounting structures with adjustable coverage patterns.

Independent aerial deterrent heads operate with stabilized housing (516), maintaining directional emitters (358), onboard battery modules (342), voice command module (412), and wireless communication (608) for enhanced patrol flexibility and comprehensive area coverage in coordination with drone platforms and ground-based units.

The system's ergonomic design includes grip contours (352) for comfortable handheld operation, while the control interface (344) provides intuitive user interaction alongside comprehensive voice command capabilities. Emergency beacon activation (610) can be triggered through manual controls or voice commands, ensuring immediate access to emergency services and automatic location broadcasting through the hybrid communication module (600).

The voice command module (412) supports multiple languages and can be trained to recognize specific user voice patterns for enhanced security and personalized operation. Voice commands include system activation, deterrent mode selection, emergency beacon activation, status inquiries, and comprehensive system control, all processed through the hybrid AI system for accurate recognition and appropriate response with confirmation feedback.

The universal attachment mechanisms (414) feature tool-free installation and removal capabilities, enabling rapid reconfiguration between deployment modes for maximum operational flexibility. The mechanisms include weatherproof sealing to maintain system integrity across all mounting configurations while providing secure, vibration-resistant connections suitable for dynamic environments and mobile applications.

Environmental resilience is achieved through weatherproof construction of battery compartments (342, 708) and weatherproof housing protecting internal components including the voice command module (412) from moisture, dust, temperature extremes, and physical impacts, enabling reliable operation across diverse environmental conditions including extreme weather, remote locations, and challenging terrain.

The thermal imaging cameras (404) provide enhanced animal detection capabilities in low-light conditions, adverse weather, and through vegetation cover, significantly improving species identification accuracy and threat assessment reliability compared to conventional visual-only systems.

The system operates across multiple frequency ranges including ultrasonic frequencies for effective humane animal deterrence and standard communication frequencies for voice command processing, data transmission, and emergency communications, ensuring optimal performance across all operational requirements.

The hybrid artificial intelligence processing seamlessly switches between local edge computing for immediate threat response and cloud-based neural networks for enhanced species recognition and behavioral analysis, with automatic fallback capabilities ensuring continuous operation regardless of network connectivity status.

What is claimed is:

1. An animal deterrent device, comprising:
a main body that includes a first shell portion removably coupled to a second shell portion, the first shell portion and the second shell portion forming a housing having an internal space;
a transducer disposed of within the internal space of the housing of the main body, the transducer configured to emit a sound wave;
a microprocessor in communication with a microphone and the transducer, and configured to execute one or more processes stored in memory, the microprocessor to perform the operations of:
at a signal processing module, capturing environmental sounds captured by the microphone and processing the environmental sounds as data to enhance and amplify at least one directional sound wave;
at an analytics machine, automatically analyzing the data to optimize the directional sound wave;
at a sound emitting control module communicating with the signal processing module and analytics machine, sending a signal to the transducer to emit the directional sound wave at a frequency capable of maintaining an animal at a distance; and
a power source for powering one or more components of the device.

2. The device of claim 1, wherein the main body includes a head portion, a shoulder portion supporting the head portion, and a handle portion.

3. The device of claim 1, wherein the main body includes a handle having a compartment space and a removable cover securely fastened to the handle to cover the compartment space.

4. The device of claim 3, wherein the microprocessor and power source are disposable within the compartment space.

5. The device of claim 1, wherein the main body includes an oval frame attached to a handle.

6. The device of claim 1, wherein optimizing the directional sound wave includes varying the sound wave's frequency based on the data captured and transmitted by the signal processing module.

7. The device of claim 1, wherein the wave's frequency ranges from 10 kHz to 45 kHz.

8. The device of claim 1, wherein two or more directional sound waves together form a directional sound wall capable of maintaining an animal a distance.

9. The device of claim 8, wherein the distance is no less than 3 feet.

10. The device of claim 1, wherein the power source is connected to a switch capable of interrupting energy supply from the power source to the one or more components powered by the power source.

11. An animal deterrent device, comprising:
a first shell portion removably coupled to a second shell portion to form a frame, the frame comprising:
a handle portion that includes a compartment space and a removable cover securely fastened to the handle to cover the compartment space;
a head portion that includes an outer frame with structural supports to provide rigidity;
a housing compartment disposed of on the head portion; and
a shoulder portion for supporting the head portion of the frame, the shoulder portion including a pair of flaring arms that are attached to the head portion on a first end and attached to the handle portion on a second end;
a transducer disposed of within the housing on the head portion, the transducer configured to emit a sound wave;
a microprocessor in communication with a microphone and the transducer, and configured to execute one or more processes stored in memory, the microprocessor to perform the operations of:
at a signal processing module, capturing environmental sounds captured by the microphone and processing the environmental sounds as data to enhance and amplify at least one directional sound wave;
at an analytics machine, automatically analyzing the data to optimize the directional sound wave;
at a sound emitting control module communicating with the signal processing module and analytics machine, sending a signal to the transducer to emit the directional sound wave at a frequency capable of maintaining an animal at a distance; and
a power source for powering one or more components of the device.

12. The device of claim 11, wherein optimizing the directional sound wave includes varying the sound wave's frequency based on the data captured and transmitted by the signal processing module.

13. The device of claim 11, wherein the wave's frequency ranges from 10 kHz to 45 kHz.

14. The device of claim 11, wherein two or more directional sound waves together form a directional sound wall capable of maintaining an animal a distance.

15. The device of claim 14, wherein the distance is no less than 3 feet.

16. An animal deterrent device, comprising:
a main body that includes a first shell portion removably coupled to a second shell portion, the first shell portion and the second shell portion forming a housing having an internal space;
a transducer disposed of within the internal space of the housing of the main body, the transducer configured to emit a sound wave;
a camera disposed of within the internal space of the main body;
a speaker disposed of within the internal space of the main body;
a microprocessor in communication with a microphone, the speaker, the transducer, and the camera, and configured to execute one or more processes stored in memory, the microprocessor to perform the operations of:
at a signal processing module, capturing environmental sounds captured by the microphone and processing the environmental sounds as data to enhance and amplify at least one directional sound wave;
at an analytics machine, automatically analyzing the data to optimize the directional sound wave;
at a sound emitting control module communicating with the signal processing module and analytics machine, sending a signal to the transducer to emit the directional sound wave at a frequency capable of maintaining an animal at a distance;
at an object recognition module, receiving image data captured by the camera and comparing the data against known object values stored in memory, and initiating a determining step:
wherein if the data does not include a known object value, nothing occurs,
wherein if the data includes a known object value, the sound emitting control module is signaled to automatically send a signal to the transducer to emit the directional sound wave;
a power source for powering one or more components of the device; and
a switch capable of interrupting energy supply from the power source powering the one or more components.

17. The device of claim 16, wherein a plurality of LEDs is disposed of on the main body, with the LEDs electronically communicating with the microprocessor.

18. The device of claim 16, wherein the wave's frequency ranges from 10 kHz to 45 kHz.

19. The device of claim 16, wherein the wave's frequency is dependent upon the object value identified by the object recognition module.

20. The device of claim 16, wherein the object recognition module can detect an object up to 25 feet away.

21. An intelligent hybrid humane animal deterrent system comprising non-lethal deterrent capabilities including:
a multivision sensor fusion system integrating thermal imaging cameras, RGB cameras, motion detection sensors, and acoustic detectors for comprehensive environmental monitoring;
directional output modules comprising ultrasonic emitters, high-intensity LED arrays, and vibration actuators mounted on adaptive swivel and tilt actuator mechanisms for dynamic targeting;
modular deployment configurations including handheld, wearable, fixed-mounted, and drone-mounted formats;
a hybrid artificial intelligence processing system combining onboard edge computing and cloud-based neural networks for real-time species recognition and behavioral threat assessment;
a hybrid communication module supporting mesh networking, satellite connectivity, mobile network interfaces, and wireless communication with automatic fallback logic;
an RFID scanning capability for pet identification and lost animal recovery;
a voice command module integrated with the communication systems for hands-free operation, emergency voice activation, and multi-language support;
universal attachment mechanisms enabling secure mounting to vest harnesses, post installations, and various deployment platforms with tool-free reconfiguration; and
a hybrid dual-battery power management system with weatherproof housing, solar charging capability, and thermal safety mechanisms.

22. The system of claim 21, wherein the multivision sensor fusion system comprises infrared thermal imaging cameras for heat signature detection, RGB video cameras for visual spectrum analysis, acoustic detection sensors for sound pattern recognition, motion detection sensors for movement tracking, and the voice command module, all integrated in a unified processing framework for comprehensive environmental analysis.

23. The system of claim 21, further comprising integration capability with smart displays and augmented reality eyewear providing real-time overlays displaying species identification, behavioral threat indicators, safety recommendations, and voice-guided instructions through graphical user interfaces.

24. The system of claim 21, wherein the drone-mounted configuration includes a gimbal-mounted head unit with wireless synchronization interface and flight navigation overlays for autonomous patrol capabilities and coordinated wildlife intrusion detection.

25. The system of claim 21, further comprising emergency beacon capabilities transmitting distress signals and location data via mesh networks and satellite connectivity, activatable through manual controls or voice commands for immediate emergency response.

26. The system of claim 21, wherein the handheld configuration comprises a detachable handle with integrated user control buttons, LED status indicators, USB charging ports, solar charging capability, and ergonomic grip contours for comfortable extended operation.

27. The system of claim 21, wherein the wearable configuration integrates into safety vest systems through the universal attachment mechanisms with chest-mounted head portions connected via secure harness attachment points for hands-free mobile operation.

28. The system of claim 21, wherein the fixed-mounted configuration utilizes the universal attachment mechanisms with mounting platforms and base supports for stationary perimeter defense applications with external power connections and adjustable emitter orientation controls.

29. The system of claim 21, wherein the adaptive swivel and tilt actuator mechanisms provide precision positioning control for real-time animal movement tracking with dynamic targeting responsive to sensor input and voice command modifications.

30. The system of claim 21, wherein the hybrid artificial intelligence processing includes local edge computing for immediate threat response and cloud-based neural networks for enhanced species recognition and behavioral analysis with seamless switching based on network availability.

31. The system of claim 21, wherein the directional output modules are configured for targeted humane deterrence with minimal environmental disruption through frequency-specific non-lethal ultrasonic emissions, directional LED illumination, and controlled vibration patterns.

32. The system of claim 21, further comprising a mobile application interface providing real-time system monitoring, manual deterrent control options, voice command configuration settings, comprehensive data logging, and emergency beacon activation.

33. The system of claim 21, wherein the hybrid dual-battery power management system features primary and secondary battery packs with intelligent charging management, weatherproof housing, solar supplementation, and runtime diagnostics for extended operation.

34. The system of claim 21, wherein the hybrid communication module enables mesh networking between multiple units for coordinated area coverage, synchronized deterrent responses, and voice command coordination across distributed deployments.

35. The system of claim 21, further comprising autonomous operation logic managing state transitions between passive monitoring mode, active deterrence mode, and emergency beacon mode based on contextual sensor input, environmental conditions, and voice command inputs.

36. The system of claim 21, wherein the RFID scanning capability includes pet identification databases, lost animal recovery functions, and data integration with mobile applications for comprehensive animal tracking and identification.

37. The system of claim 21, further comprising memory and logging modules for sensor event storage, species detection records, deterrent response patterns, voice command logs, and adaptive learning algorithms enabling continuous system improvement and optimization.

38. The system of claim 21, wherein the thermal imaging cameras provide enhanced animal detection capabilities in low-light conditions, adverse weather, and through vegetation cover for improved species identification accuracy.

39. The system of claim 21, wherein the system operates across multiple frequency ranges including ultrasonic frequencies for humane animal deterrence and standard communication frequencies for voice command processing and data transmission.

40. The system of claim 21, wherein the voice command module supports multiple languages, user voice pattern recognition for enhanced security, and processes commands including system activation, deterrent mode selection, emergency beacon activation, and comprehensive status inquiries.

41. The system of claim 21, wherein the universal attachment mechanisms feature quick-release connectors, threaded mounting interfaces, adjustable clamp systems, and weatherproof sealing enabling rapid reconfiguration between deployment modes while maintaining secure, vibration-resistant connections.

42. A method for intelligent hybrid humane animal deterrence comprising non-lethal deterrent methods including:
detecting animal presence using multivision sensor fusion combining thermal imaging, RGB cameras, motion sensors, acoustic detectors, and voice command input for comprehensive environmental monitoring;
processing sensor data and voice commands through hybrid artificial intelligence algorithms combining local edge computing and cloud-based analysis for species recognition and behavioral threat assessment;
determining appropriate deterrent response based on species identification, behavioral analysis, environmental conditions, and user voice commands;
activating directional deterrent outputs including ultrasonic emissions, visual signals, and vibrational patterns through adaptive targeting mechanisms responsive to real-time tracking and voice control;
logging encounter data, response effectiveness, and voice command interactions for system learning and optimization; and
providing user alerts, safety recommendations, and system status through mobile applications, augmented reality interfaces, and voice feedback systems.

43. The method of claim 42, further comprising coordinating multiple deterrent units through hybrid mesh networking for enhanced area coverage, synchronized response patterns, and distributed voice command coordination across multiple deployment locations.

44. The method of claim 42, wherein the species recognition includes differentiation between threatening and non-threatening animal behaviors to minimize false activations and environmental disruption, with voice override capabilities for manual intervention.

45. The method of claim 42, further comprising emergency beacon activation for distress signal transmission via satellite and mesh networks when dangerous animal encounters are detected or voice emergency commands are received, including automatic location broadcasting.

46. The method of claim 42, wherein the adaptive targeting includes real-time adjustment of deterrent direction, intensity, and frequency based on animal movement patterns, response effectiveness, and voice command modifications for optimal deterrence results.

47. An intelligent modular hybrid humane animal deterrent device providing non-lethal deterrent capabilities comprising:
an enhanced head portion housing multivision sensors including thermal imaging cameras, RGB cameras, motion detection sensors, acoustic detectors, RFID scanners, and a voice command module for comprehensive environmental monitoring;
universal attachment mechanisms integrated into the enhanced head portion for secure mounting to vest harnesses, post installations, drone platforms, and various deployment configurations;
a detachable handle portion with integrated user controls, battery compartments, charging interfaces, solar capability, and user feedback systems;
hybrid artificial intelligence processing modules combining local edge computing and cloud-based analysis for real-time species identification, behavioral assessment, and voice command processing;
directional deterrent emitters mounted on precision swivel and tilt mechanisms for dynamic targeting responsive to sensor input and voice commands;
hybrid wireless communication systems supporting mesh networking, satellite connectivity, and mobile networks with voice command integration and automatic fallback logic;
modular mounting systems enabling seamless transitions between handheld, wearable, fixed, and aerial deployment configurations; and
comprehensive power management featuring dual batteries, solar charging, thermal protection, and intelligent energy optimization.

48. The device of claim 47, wherein the enhanced head portion maintains a distinctive circular form factor with cross-pattern structural elements while integrating advanced sensor arrays, processing capabilities, and voice command technologies for optimal performance and recognition.

49. The device of claim 47, wherein the universal attachment mechanisms include quick-release connectors, threaded mounting interfaces, adjustable clamp systems, and weatherproof sealing for versatile deployment across multiple configurations with tool-free operation and secure connections.

50. The device of claim 47, wherein the modular mounting systems include universal interfaces compatible with drone platforms, vehicle mounts, stationary installations, and wearable gear through the integrated attachment mechanisms for maximum deployment flexibility.

51. The device of claim 47, further comprising independent aerial operation capability with stabilized housing, wireless coordination, and autonomous patrol functions with voice command. control for enhanced coverage and operational flexibility.

52. The device of claim 47, wherein the hybrid artificial intelligence processing includes seamless switching between local and cloud-based analysis with automatic fallback to edge computing when network connectivity is unavailable, maintaining full voice command functionality in all operational modes.

53. The device of claim 47, further comprising augmented reality integration providing real-time species identification overlays, behavioral threat indicators, safety guidance, and voice-guided instructions through compatible smart displays and eyewear systems.

54. The device of claim 47, wherein the voice command module processes multiple languages, recognizes specific user voice patterns for enhanced security, and integrates with all system functions including deterrent activation, mode selection, emergency response, and comprehensive system control.

55. The device of claim 47, wherein the hybrid communication systems enable seamless switching between local processing, mesh networking, satellite connectivity, and mobile networks while maintaining voice command capabilities and ensuring reliable operation across all communication modes and environmental conditions.
